(19) United States
(12) Patent Application Publication
(10) Pub. No.: US 2002/0191483 A1
(43) Pub. Date: Dec. 19, 2002

(54) Fluid mixing apparatus

(76) Inventors: Satoshi Ohtsuki, Minami-ku (JP); Kazuki Makimura, Fushimi-ku (JP)

Correspondence Address: Jeremy J. Curcuri, Brooks & Kushman P.C., 22nd Floor, 1000 Town Center, Southfield, MI, 48075-1351, US

(21) Appl. No.: 10/114,783

(22) Filed: Apr. 3, 2002

(30) Foreign Application Priority Data
Apr. 11, 2001 (JP) 2001-113167

(51) Int. Cl. B01F 3/02

(52) U.S. Cl. 366/107

(57) ABSTRACT

A fluid mixing apparatus includes a pipe in which fluid flows, an injection section for injecting an injection gas into the fluid and a supplying section for supplying the injection gas to the injection section. The apparatus further includes at least one element downstream of the injection section and/or an injection tube in the injection section to uniformly distribute and/or inject the injection gas into the fluid.

### BACKGROUND OF THE INVENTION

1. Field of the Invention

The present invention relates to a fluid mixing apparatus.

2. Background Art

In a conventional fluid mixing apparatus, an exhaust gas G flows in an exhaust pipe 81 in direction A. The exhaust pipe is connected to a tailpipe connecting to an automobile engine. An injection tube 82 bended in the form of a letter L injects an injection gas G′ into the exhaust gas G from an injection port 83 inserted into the exhaust pipe 81 as shown in FIG. 13. Uniformity of mixing is secured by allowing sufficient space between an injection location S where injection port 83 is positioned and a sampling location F downstream therefrom, requiring an exhaust pipe of a sufficient length such as 1000 mm or more. In addition, when the flow of the exhaust gas is a laminar flow and the turbulence of the flow of the exhaust gas is small, there is a possibility that a sufficient uniformity is not attained even when the exhaust pipe 81 has considerable length.

### SUMMARY OF THE INVENTION

It is, therefore, an object of the present invention to provide a fluid mixing apparatus capable of uniformly mixing an exhaust gas and an injection gas in an exhaust pipe at a short distance regardless of the condition of fluid flowing in the pipe.

In carrying out the above object, a fluid mixing apparatus is provided. The apparatus includes a pipe in which fluid flows, an injection section for injecting an injection gas into the fluid and a supplying section for supplying the injection gas to the injection section. The apparatus further comprises at least one element downstream of the injection section. The at least one element extends inwardly from a surrounding wall of the pipe to agitate the injection gas and the fluid and to uniformly distribute the injection gas in the fluid.

The at least one element downstream of the injection section may take many forms. In one embodiment, the at least one element comprises at least one column element having a top end and a bottom end with both the top end and the bottom end being secured to the surrounding wall of the pipe. Preferably, the at least one element further comprises a first column element downstream of the injection section and a second column element downstream of the first column element. Alternatively, the at least one element comprises a plurality of branched tube sections extending radially from a central section in various directions.

In a preferred embodiment, the apparatus further comprises an injection tube in the injection section. The injection tube includes a central section and at least one branched tube section. The at least one branched tube section extends outwardly from the central section and has a plurality of holes directed upstream for uniformly injecting the injection gas. The injection tube may take many forms. Preferably, the injection tube comprises a plurality of branched tube sections branching radially from the central section in various directions. The plurality of holes are uniformly spaced about a cross-section of the pipe.

Further, in carrying out the present invention, a fluid mixing apparatus is provided. The apparatus includes a pipe in which fluid flows, an injection section for injecting an injection gas into the fluid and a supplying section for supplying the injection gas to the injection section. The apparatus further comprises an injection tube in the injection section. The injection tube includes a central section and at least one branched tube section. The at least one branched tube section extends outwardly from the central section and has a plurality of holes directed upstream for uniformly injecting the injection gas.

The injection tube may take many forms. Preferably, the injection tube comprises a plurality of branched tube sections branching radially from the central section in various directions. The plurality of holes are uniformly spaced about a cross-section of the pipe.

The advantages associated with embodiments of the present invention are numerous. For example, the fluid flowing through the pipe may be an automobile exhaust gas or the like. The injection gas may be a trace gas.

The above object and other objects, features, and advantages of the present invention are readily apparent from the following detailed description of the preferred embodiments when taken in connection with the accompanying drawings.

### BRIEF DESCRIPTION OF THE DRAWINGS

FIG. 1 is a perspective view showing a first embodiment of the present invention;

FIG. 2 is a cross-sectional view of the first embodiment;

FIG. 3(A) is a front view of an injection tube in the first embodiment, and

FIG. 3(B) is a vertical sectional view of the injection tube in the first embodiment;

FIG. 4(A) is a plan view of a pipe in the first embodiment, and

FIG. 4(B) is a vertical sectional view of the pipe in the first embodiment;

FIG. 5(A) illustrates measuring points in the first embodiment, and

FIG. 5(B) illustrates the construction in the first embodiment;

FIG. 6 is a front view showing an alternative for the injection tube in the first embodiment;

FIG. 7 is a front view showing another alternative for the injection tube in the first embodiment;

FIG. 8 is a front view showing another alternative for the injection tube in the first embodiment;

FIG. 9 is a perspective view showing a second embodiment of the present invention;

FIG. 10 is a perspective view showing a third embodiment of the present invention;

FIG. 11 is a perspective view showing a fourth embodiment of the present invention;

FIG. 12 is a perspective view showing a fifth embodiment of the present invention; and

FIG. 13 illustrates a conventional fluid mixing apparatus.

### DETAILED DESCRIPTION OF THE PREFERRED EMBODIMENTS

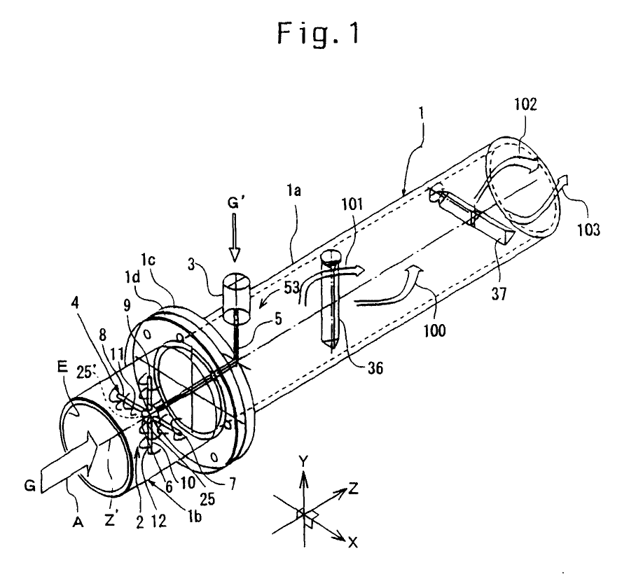

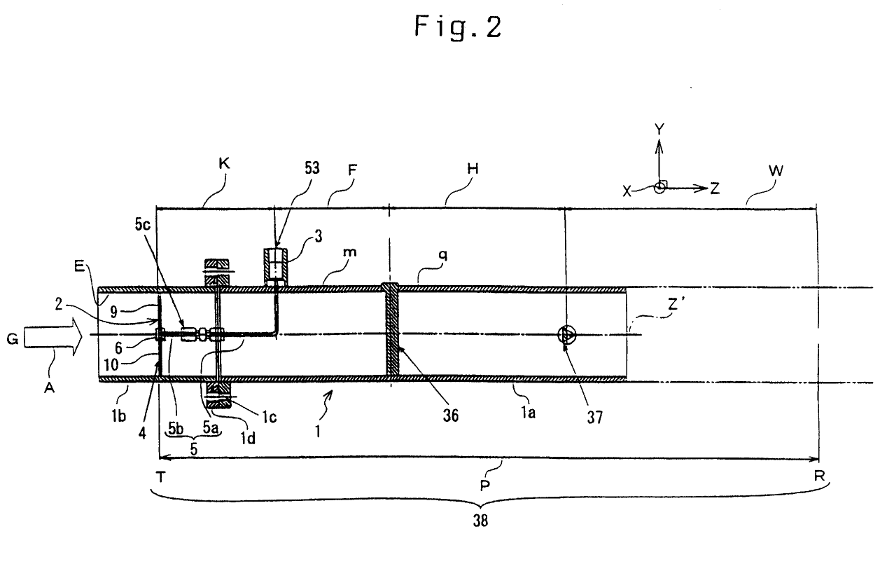

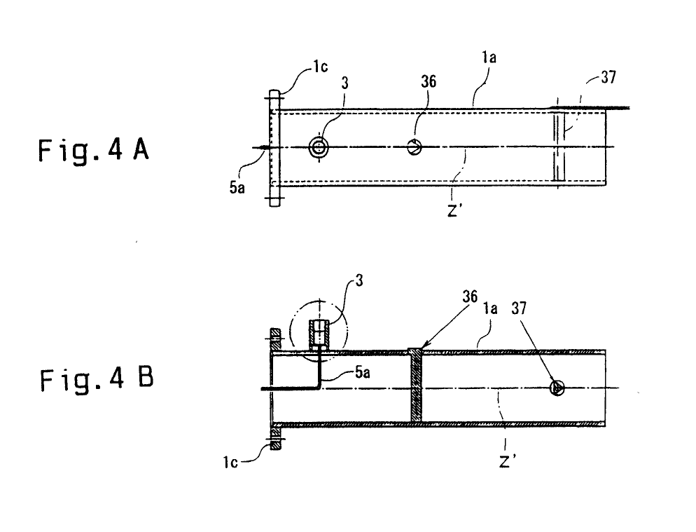

FIGS. 1-5 show a first embodiment of the present invention which allows a substance to be injected (injection gas) into a pipe and to mix uniformly at a short distance regardless of the condition of the fluid flowing in the pipe.

In FIGS. 1-5, reference numeral 1 designates a pipe such as, for example, an exhaust pipe connected to a tailpipe connecting to an automobile engine. Pipe 1 consists of a mixing section la positioned downstream and a joint section 1b positioned upstream. Pipe 1 links to, for example, a constant volume sampling system (not shown) installed downstream. Reference numeral 1c designates a flange directed radially outward, provided at the upstream end of the mixing section 1a, and reference numeral Id designates a flange directed radially outward, provided at the downstream end of the joint section 1b.

Reference numeral 2 designates an injection section constructed with a tubular element having a plurality of injection holes 11, 12, 25 of small diameters for uniformly injecting the injection gas G′ (substance to be injected) into the exhaust gas G. And, in this embodiment, the injection holes 11, 12, 25 are directed upstream so as to inject the injection gas G′ in the reverse direction relative to the direction of flow of the exhaust gas G (the gas main stream) in the pipe 1 (direction shown by the arrow A) to mix the exhaust gas G more uniformly when mixing the exhaust gas G with the injection gas G′ (substance to be injected).

Injection section 2 consists of an injection tube 4, provided in the pipe 1, having the shape of a cross in a front view. A tubular injection gas supplying port 3 is installed in a standing manner on the outer peripheral surface m of the pipe 1, and has a linking tube 5 linking to injection tube 4. And, a substance-to-be-injected supplying section 53 for supplying the injection gas G′ to the injection section 2 is composed of the injection gas supplying port 3 and the linking tube 5.

Linking tube 5 consists of an L-shaped tube 5a bended in the form of a letter L with the upstream end thereof linked to supplying port 3 and a horizontal tube 5b of which the downstream end links to central section 6 of injection tube 4, and these tubes 5a and 5b are mutually linked with a fitting 5c.

Further, injection tube 4 is installed a distance K upstream from supplying port 3. Injection tube 4 consists of central section 6 provided at the position of an axial center Z′ of pipe 1, one pair of branched tube sections 7, 8 branched from central section 6 in the right direction and the left direction of a lateral axis (X-axis), respectively, when central section 6 is viewed from the front, and one pair of branched tube sections 9, 10 branched from central section 6 in the upper direction and the lower direction of a vertical axis (Y-axis), respectively. That is, injection tube 4 is composed of two pairs of branched tube sections 7, 8, 9, 10, and branched tube section 7 and branched tube section 8 are in the same straight line L, and branched tube section 9 and branched tube section 10 are also in the same straight line M, and these straight lines L, M are orthogonal to each other.

Branched tube sections 7, 8 have a plurality of injection holes 11 of small diameters directed upstream. The injection hole 11 of the branched tube section 7 and the injection hole 11 of the branched tube section 8 are in a relationship of being symmetric with respect to an axis about the position of the axial center Z′.

Branched tube sections 9, 10 also have a plurality of injection holes 12 of small diameters directed upstream. The injection hole 12 of the branched tube section 9 and the injection hole 12 of the branched tube section 10 are in a relationship of being symmetric with respect to an axis about the position of the axial center Z (central position 25′). And, the central section 6 is circular in a front view, and has a single injection hole 25 directed upstream not at a central position (position of intersection of the two straight lines L, M) 25′ but at a position deviating from the central position 25′ in the radial direction by the minimal length Δ. The reason for doing so is that since the linking tube 5 links directly to the central position 25′ of the central section 6 in contrast to two pairs of branched tube sections 7, 8, 9, 10, the flow of the injection gas G′ from the linking tube 5 impinges directly upon the central position 25′, and therefore an injection rate supplied from the single injection hole becomes more than that from the injection holes 11, 12 if the single injection hole directed upstream is provided at the central position 25′. That is, since the injection hole 25 is provided at the position deviating from the central position 25′, it is possible to make the injection rate from the injection hole 25 equivalent to that from the injection holes 11, 12. It is preferred in terms of leveling of the injection rate to adopt the construction in which the injection hole 25 is deviated from the central position, but the present invention is not necessarily limited to that construction.

In other words, in this embodiment, a plurality of injection (blowing) holes 11, 12, 25 directed upstream are provided at the injection tube 4, and, for the purpose of injecting the gas G′ from these injection holes 11, 12, 25 at the position being symmetric with respect to an axis relative to the gas main stream as far as possible, the branched tube sections 7, 8, 9, 10 composing the injection tube 4 are formed in the shape of a cross in a front view extending radially in the direction of a diameter of the pipe 1 from the position of the axial center Z′ and the injection holes 11, 12, 25 are positioned in a condition of being symmetric with respect to an axis. Further, in this embodiment, injection tube 4 is constructed in such a way that the injection gas G′ supplied from the injection gas supplying port 3 through the linking tube 5 is injected in the reverse direction relative to the direction of the gas main stream (direction shown by the arrow A) by providing the injection holes 11, 12, 25 on the upstream side. Thus, since the injection holes 11, 12, 25 are positioned in a state of being symmetric with respect to an axis and provided on the upstream side, it is possible to mix the injection gas G′ and the exhaust gas G more uniformly.

Further, in this embodiment, as one example of the injection tube having a configuration extending radially in the direction of a diameter of the pipe 1 from the position of the axial center Z′, the injection tube of the shape of a cross in a front view, which consists of orthogonal two pairs of branched tube sections 7, 8, 9, 10, is shown, but not less than three pairs of branched tube sections may also be used as the injection tube of the present invention.

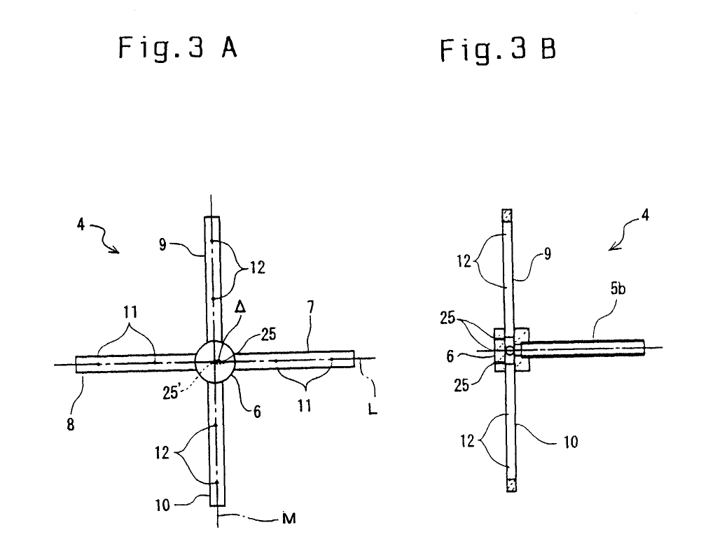

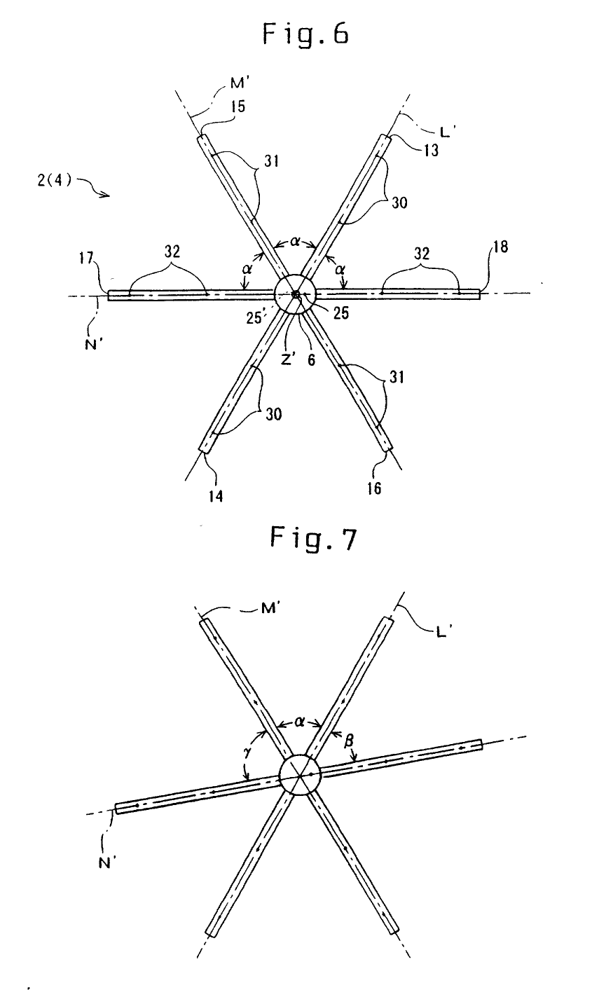

As shown, for example, in FIG. 6, the injection tube 4 is composed of three pairs of branched tube sections 13, 14, 15, 16, 17, 18, and the branched tube sections 13, 14 are both in the same straight line L′, the branched tube sections 15, 16 in the same straight line M′ and the branched tube sections 17, 18 also in the same straight line N′. These straight lines L′, M′, N′ cross each other at the same angle α (60°) and at the position of the axial center Z′ of the pipe 1. The branched tube sections 13, 14 have a plurality of injection holes 30 of small diameters directed upstream. The branched tube sections 15, 16 have a plurality of injection holes 31 of small diameters directed upstream. The branched tube sections 17, 18 have a plurality of injection holes 32 of small diameters directed upstream. In FIG. 6, similar reference characters to that shown in FIG. 3 designate similar or corresponding parts.

However, as shown in FIG. 7, the branched tube sections of which the straight lines L′, M′ cross each other at the angle α but the straight lines L′, N′ mutually and the straight lines M′, N′ mutually cross each other at the angle β and at the angle γ, respectively, which are respectively different from the angle α may be adopted. However, the angles β and γ are nearly equal to the angle α.

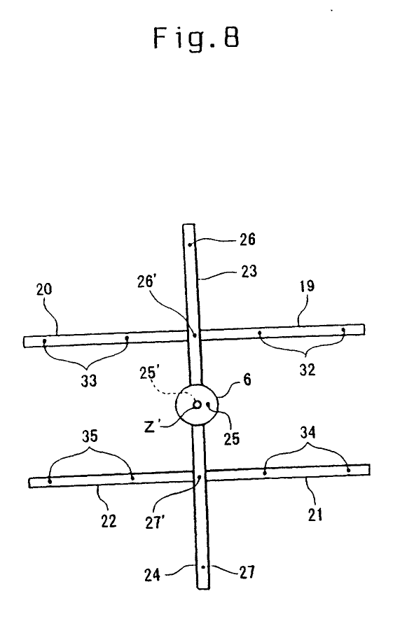

Furthermore, as the injection tube of the present invention, an injection tube having the configuration as shown in FIG. 8 in a front view may also be adopted. In FIG. 8, though horizontal branched tube sections 19, 20, 21, 22 positioned above and below the central section 6, respectively, do not cross each other at the position of the axial center Z′ of the pipe 1, they are positioned at upper and lower locations at same distances from a central horizontal plane, and cross branched tube sections 23, 24, respectively, which extend in the upper and the lower directions through the central section 6, at angles of 90°. And, the branched tube sections 19, 20 have a plurality of injection holes 32, 33 of small diameters directed upstream. The injection hole 32 provided on the right side and the injection hole 33 provided on the left side are in a relationship of being symmetric with respect to an axis. The branched tube sections 21, 22 have a plurality of injection holes 34, 35 of small diameters directed upstream. The injection hole 34 and the injection hole 33 are in a relationship of being symmetric with respect to an axis. And, the branched tube sections 23, 24 have also a plurality of injection holes 26, 27 of small diameters directed upstream. The injection hole 26 and the injection hole 27 are in a relationship of being symmetric with respect to an axis about the position of the axial center Z′. Further, an injection hole 26′ is provided at the position where the branched tube sections 19, 20 and the branched tube sections 23, 24 cross each other, and an injection hole 27′ is provided at the position where the branched tube sections 21, 22 and the branched tube sections 23, 24 cross each other. The injection hole 26′ and the injection hole 27′ are also in a relationship of being symmetric with respect to an axis about the position of the axial center Z′.

And, as the injection tube of the present invention, the injection tube formed by combining that of a type extending radially in the direction of a diameter of the pipe 1 like FIGS. 3 and 6 and that of a type shown in FIG. 8 may also be applied. It is essential to these embodiments only that the configuration of the injection tube be able to inject the injection gas G′ from the injection holes symmetrically with respect to an axis relative to the gas main stream as far as possible.

Reference numerals 36, 37 designate the small column elements for agitating having identical configurations, and they are installed downstream of the injection section 2 allowing a space H between them.

The above-mentioned small column element 36 for agitating forms the configuration of a triangular prism in this embodiment, and the longitudinal direction thereof is orthogonal to the direction of the flow of the exhaust gas G (direction shown by the arrow A) along the direction of the Y-axis, and the axial center Z′ of the pipe 1 passes through the central position of the small column element in the longitudinal direction, and both top and bottom ends thereof are secured to the surrounding wall q of the pipe 1. This small column element 36 is installed at a downstream distance F from the position of the above-mentioned injection gas supplying port 3. It is appreciated column elements 36, 37, 62 may be made as various shapes in addition to triangular prisms. As such, it is appreciated that the term column means any element installed downstream of injection section 2 that agitates fluid flow, and that the illustrations in the drawings are examples.

And, the straight flow of the mixture of the gases formed by mixing the injection gas G′ into the exhaust gas G in the direction of the gas main stream (direction shown by the arrow A) is obstructed by the small column element 36, and a rightward-directing stream 100 and a leftward-directing stream 101 are produced in the flow of the mixture of the gases.

On the other hand, the small column element 37 for agitating has the same configuration as the small column element 36, and the longitudinal direction thereof is orthogonal to the direction of the flow of the exhaust gas G (direction shown by the arrow A) along the direction of the X-axis, and the axial center Z′ of the pipe 1 passes through the central position of the small column element in the longitudinal direction, and both right and left ends thereof are secured to the surrounding wall q of the pipe 1. This small column element 37 is installed at a downstream distance H from the position of the small column element 36 as described above. That is, the small column elements 36, 37 for agitating are provided in such a way that the two small column elements form the angle of 90° mutually in the radial direction of the pipe 1.

And, the straight flows of the above-mentioned rightward-directing stream 100 and the above-mentioned leftward-directing stream 101 of the mixture of the gases in the direction of the gas main stream (direction shown by the arrow A) are obstructed by the small column element 37 and an upward-directing stream 102 and a downward-directing stream 103 are produced in the flow of the mixture of the gases. By a combination of the rightward-directing stream 100 and the leftward-directing stream 101, and the upward-directing stream 102 and the downward-directing stream 103, a Karman's vortex is generated downstream of the small column element 37 in the pipe 1. And, the mixture of the gases G, G′ is agitated uniformly by the Karman's vortex and therefore the mixture of the gases G, G′ flowing in the pipe 1 is mixed uniformly at a shorter distance even though the flow of the exhaust gas G (the gas main stream) in the pipe 1 is a laminar flow and the turbulence of the flow of the gas main stream is small. In other words, the mixture of the gases flowing in the pipe 1 is sufficiently mixed in the mixing region 38 of a short distance.

The above-mentioned mixing region 38 is that formed between an injection location T where the injection tube 4 is positioned and a sampling location R downstream therefrom, and the distance of the mixing region 38 is denoted by a letter P. Further, the distance between the small column element 37 for agitating and the sampling location R is denoted by a letter W.

The average concentrations of the injection gas G′ based on the above-mentioned construction in the pipe 1 were measured under varying conditions as follows.

Conditions of measurement were as follows:

(1) SF₆ gas was used as the injection gas G′, and this gas was injected at a rate of about 500 milliliter per minute.

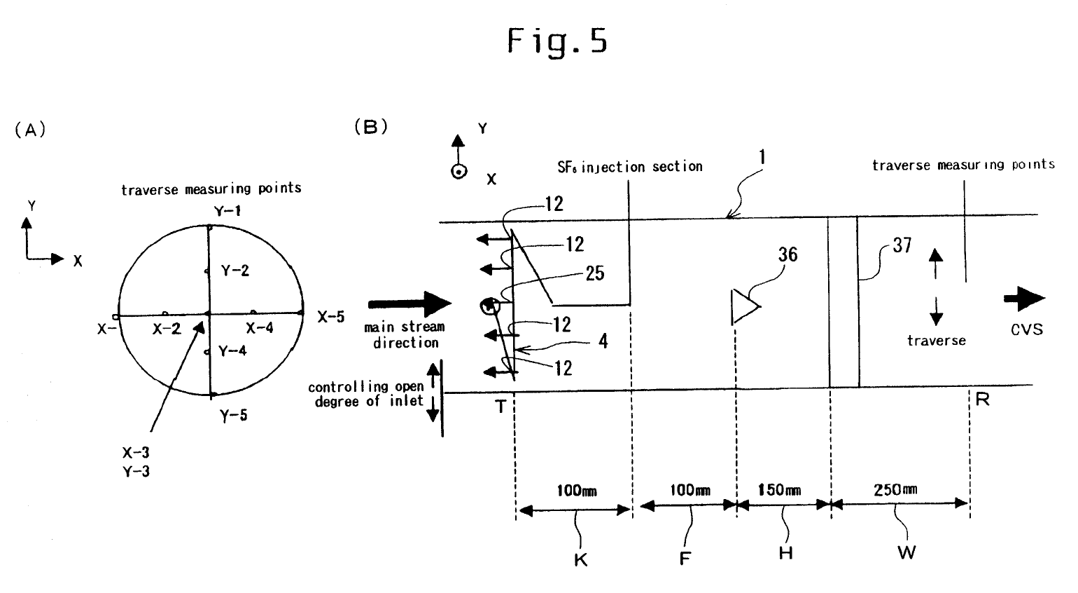

(2) After the distance K between the injection tube 4 and the injection gas supplying port 3 was set at 100 mm, the distance F between the above-mentioned supplying port 3 and the small column element 36 for agitating was set at 100 mm and the space H between the small column elements 36, 37 for agitating was set at 150 mm as shown in FIG. 5(B), the concentration of SF₆ gas was measured at the sampling location R.

(3) The pipe 1 was not connected to the tailpipe, and the inlet F of the pipe 1 was appropriately blocked and the respective flow rates of the gas main streams were achieved.

(4) The sampling location R was positioned at 250 mm downstream from the small column element 37 for agitating.

Results of measurement were as follows:

Result 1: Measurements in the case where the flow rate of the gas main stream is about 100 liter per minute are shown in the following Table 1.

TABLE 1
Flow rate of main stream about 100 L/min.
(correspond to idling of car which exhausts about 1500 cc

| | | | SF₆ concentration (ppm) |
|---|---|---|---|
| | SF₆ concentration | | (measured about an hour after |
| Point | (ppm) | Point | measurement in X-direction) |
| X-1 | 816 | Y-1 | 834 |
| X-1 | 818 | Y-1 | 834 |
| X-2 | 816 | Y-2 | 827 |
| X-2 | 816 | Y-2 | 834 |
| X-3 | 812 | Y-3 | 828 |
| X-3 | 814 | Y-3 | 834 |
| X-4 | 814 | Y-4 | 829 |
| X-4 | 815 | Y-4 | 837 |
| X-5 | 813 | Y-5 | 834 |
| X-5 | 814 | Y-5 | 836 |
| average | 814.8 | average | 832.7 |
| standard | 1.75119 | standard | 3.433495 |
| deviation | | deviation | |
| CV(%) | 0.21 | CV(%) | 0.41 |

Result 2: Measurements in the case where the flow rate of the gas main stream is about 350 liter per minute are shown in the following Table 2.

TABLE 2
Flow rate of main stream about 350 L/min.
(correspond to car running at 50 km/h which exhausts about 1500 cc)

| | SF₆ concentration | | SF₆ concentration |
|---|---|---|---|
| Point | (ppm) | Point | (ppm) |
| X-1 | 248 | Y-1 | 247 |
| X-1 | 248 | Y-1 | 248 |
| X-2 | 249 | Y-2 | 247 |
| X-2 | 249 | Y-2 | 247 |
| X-3 | 247 | Y-3 | 249 |
| X-3 | 250 | Y-3 | 247 |
| X-4 | 247 | Y-4 | 250 |
| X-4 | 247 | Y-4 | 248 |
| X-5 | 247 | Y-5 | 250 |
| X-5 | 248 | Y-5 | 248 |
| average | 248 | average | 248.1 |
| standard | 1.054093 | standard | 1.197218 |
| deviation | | deviation | |
| CV(%) | 0.43 | CV(%) | 0.48 |

Result 3: Measurements in the case where the flow rate of the gas main stream is about 3000 liter per minute are shown in the following Table 3.

TABLE 3
Flow rate of main stream about 3000 L/min.
(correspond to max flow rate of car which exhausts about 1500 cc

| | SF₆ concentration | | SF₆ concentration |
|---|---|---|---|
| Point | (ppm) | Point | (ppm) |
| X-1 | 30.2 | Y-1 | 29.5 |
| X-1 | 30.1 | Y-1 | 29.5 |
| X-2 | 30.5 | Y-2 | 29.5 |
| X-2 | 30.4 | Y-2 | 29.5 |
| X-3 | 30.8 | Y-3 | 29.5 |
| X-3 | 30.4 | Y-3 | 29.5 |
| X-4 | 30.5 | Y-4 | 29.6 |
| X-4 | 30.5 | Y-4 | 29.7 |
| X-5 | 30.6 | Y-5 | 29.7 |
| X-5 | 30.5 | Y-5 | 29.6 |
| average | 30.45 | average | 29.56 |
| standard | 0.195789 | standard | 0.084327 |
| deviation | | deviation | |
| CV(%) | 0.64 | CV(%) | 0.29 |

Though these measuring locations (sampling location R) were 0.6 m downstream from the injection location T, measurements in the case where the flow rate of the gas main stream is about 3000 liter per minute and the measuring location are set to be about 7.0 m downstream from the injection location T (location for the mixture of gases to be mixed sufficiently) are shown in the following Table 4.

TABLE 4
Flow rate of main stream about 3000 L/min.
(correspond to max flow rate of car which exhausts about 1500 cc)
Measuring locations are about 7.0 m downstream from injection
location to measure an ideal condition in which gases are mixed
sufficiently.

| | SF₆ concentration | | SF₆ concentration |
|---|---|---|---|
| Point | (ppm) | Point | (ppm) |
| X-1 | 29.5 | Y-1 | 28.2 |
| X-1 | 29.1 | Y-1 | 28.9 |
| X-2 | 29.5 | Y-2 | 29.2 |
| X-2 | 29.4 | Y-2 | 28.6 |
| X-3 | 29.4 | Y-3 | 29.3 |
| X-3 | 29.5 | Y-3 | 28.5 |
| X-4 | 29.2 | Y-4 | 29.5 |
| X-4 | 29.4 | Y-4 | 28.9 |
| X-5 | 28.8 | Y-5 | 29.3 |
| X-5 | 29.2 | Y-5 | 28.8 |
| average | 29.3 | average | 28.92 |
| standard | 0.226078 | standard | 0.41042 |
| deviation | | deviation | |
| CV(%) | 0.77 | CV(%) | 1.42 |

Here, it is found that values in Tables 1-3 show the substantially equivalent or more values in uniformity compared with the data of Table 4, which represent measurements at the location for the mixture of gases to be mixed sufficiently. That is, it is understood from Tables 1-3 that there are not much differences in the concentrations of SF₆ gas at respective points in the measuring location R being 0.6 m downstream from the injection location T and the mixture of gases was mixed uniformly. In other words, both of CV % and standard deviation of Tables 1-3 show lower values than that of Table 4. Accordingly, it is understood from Tables 1-4 that the mixture of gases may be mixed uniformly at a short distance and an ideal condition of mixing may be attained in the present invention.

That is, since a plurality of small column elements 36, 37 for agitating are installed with the small column elements different in installation angles in the radial direction of the pipe 1 and with a space between them downstream of the injection gas supplying port 3, and further the injection tube 4 of the shape of a cross in a front view, which links to the injection gas supplying port 3 through the linking tube 5 including the L-shaped tube 5a with the injection holes 11, 12, 25 directed upstream in the pipe 1, is provided upstream from the injection gas supplying port 3, and the injection gas G′ is injected at the position being symmetric with respect to an axis as far as possible from the injection holes 11, 12, 25, the injection gas G′ injected into the pipe 1 may be mixed uniformly at a shorter distance by agitating effect (generation of the Karman's vortex) of the flow of the mixed gas resulting from allowing the above-mentioned small column elements 36, 37 for agitating to be different in installation angles. That is, by using the pipe having the mixing region 38 of a short distance according to the construction described above, it is possible to make the concentration distribution of the injection gas G′ uniform even though the flow of the exhaust gas G (the gas main stream) in the pipe 1 is a laminar flow and the turbulence of the flow of the gas main stream is small.

The small column elements 36, 37 for agitating are shown having the configuration of a triangular prism, however, small column elements for agitating having the configuration of a polygonal prism such as a tetragonal prism and a hexagonal prism or a cylindrical column or other shapes may also be applicable to the present invention.

And, in this embodiment, there is shown the injection tube 4 of the configuration capable of injecting the above-mentioned gas G′ from the injection holes 11, 12, 25 symmetrically with respect to an axis relative to the gas main stream as far as possible to uniformly inject the injection gas G′, (substance to be injected) to the exhaust gas G, but when the injection tube is used in combination with the small column elements 36, 37 for agitating having the function to generate the Karman's vortex for agitating the mixture of the gases G, G′ downstream thereof like this embodiment, the injection tube is not limited to the injection tube 4 of the above-mentioned configuration, and it is possible to mix the mixture of these gases uniformly at a short distance regardless of the condition of the flow of the exhaust gas G flowing in the pipe 1 also when the injection tube of any configuration is used.

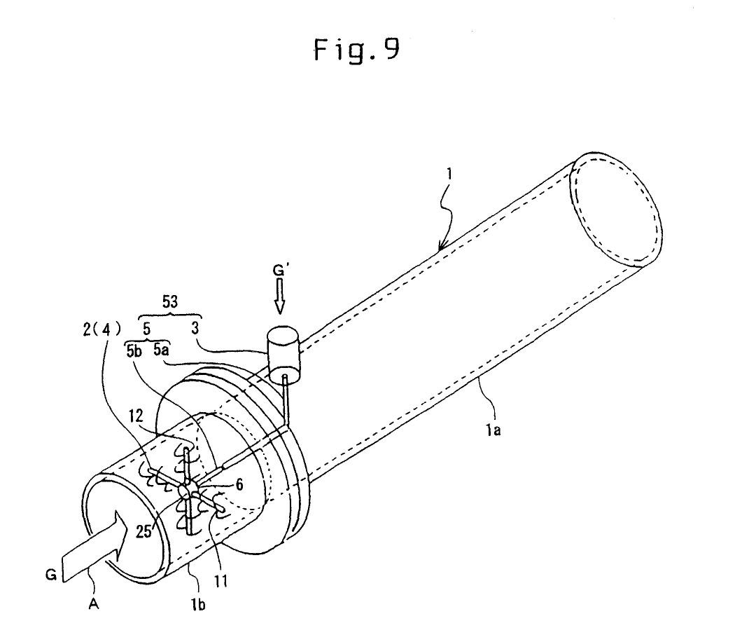

Though, in the above-mentioned embodiment, an apparatus formed by combining the small column elements for agitating 36, 37 and the injection section 2 is shown, FIG. 9 shows a second embodiment of the present invention in which, in the fluid mixing apparatus which has the pipe 1 in which the exhaust gas G flows, the injection section 2 (4) for injecting the injection gas (substance to be injected) G′ into the exhaust gas G and the substance-to-be-injected supplying section 53 for supplying the injection gas (substance to be injected) G′ to the injection section 2 (4), the exhaust gas G and the injection gas (substance to be injected) G′ are mixed, and the injection section 2 (4) is constructed by the tubular element having a plurality of injection holes 11, 12, 25 for injecting the injection gas (substance to be injected) G′ uniformly. That is, in this embodiment, the small column elements for agitating 36, 37 of the embodiment described above are not used, and means capable of mixing uniformly at a short distance regardless of the condition of the flow of the exhaust gas G flowing in the pipe 1 is composed of the injection gas supplying port 3, the linking tube 5 consisting of the L-shaped tube 5a and the horizontal tube 5b and the injection section 2 consisting of the injection tube 4 of the shape of a cross in a front view, which has a plurality of the injection holes 11, 12, 25, directed upstream, having small diameters. In FIG. 9, similar reference characters to that shown in FIGS. 1 to 8 designate similar or corresponding parts. This embodiment is effective when the turbulence of the flow of the exhaust gas G (the gas main stream) in the pipe 1 is sufficiently large.

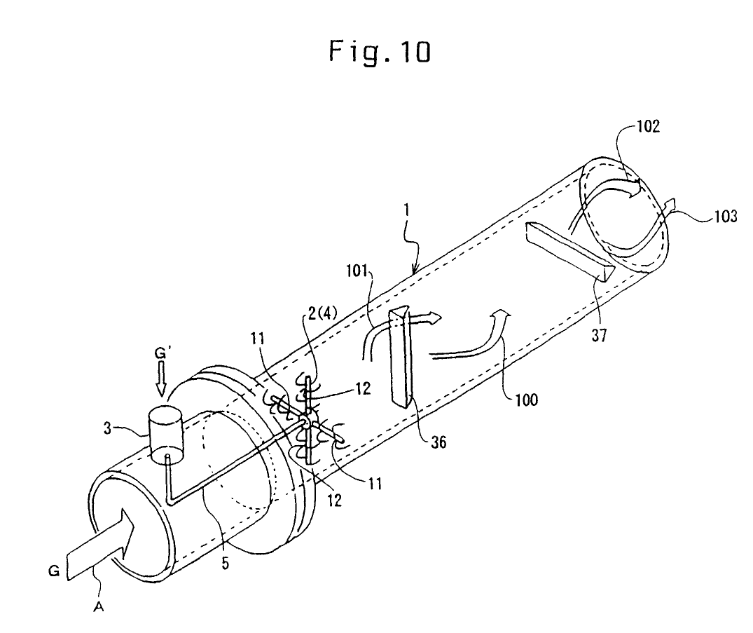

FIG. 10 shows the third embodiment of the present invention in which the injection tube 4 of the shape of a cross in a front view is installed downstream from the injection gas supplying port 3 with a plurality of the injection holes 11, 12 having small diameters directed upstream. In FIG. 10, similar reference characters to that shown in FIGS. 1 to 9 designate similar or corresponding parts.

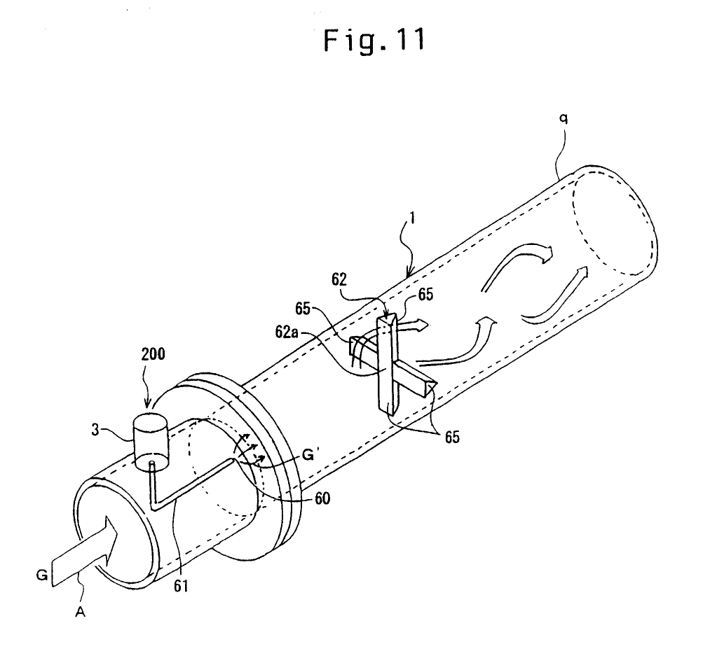

FIG. 11 shows the fourth embodiment of the present invention constructed in such a way that the L-shaped tube 61 bended in the form of a letter L in a state of directing the injection port 60 downstream is connected to the injection gas supplying port 3, and the small column element 62 for agitating having the configuration extending radially in the direction of a diameter of the pipe 1 (for example, the shape of a cross in a front view) is installed in the pipe 1 to generate the Karman's vortex downstream of the small column element 62. In FIG. 11, similar reference characters to that shown in FIGS. 1 to 10 designate similar or corresponding parts. In this embodiment, the injection gas supplying port 3 and the L-shaped tube 61 form the injection section 200.

The straight flow of the mixture of the gases formed by mixing the injection gas G′ into the exhaust gas G to the above-mentioned direction of the gas main stream (direction shown by the arrow A) is obstructed by the small column element 62 for agitating having the shape of a cross in a front view, and a rightward-directing stream, a leftward-directing stream, an upward-directing stream and a downward-directing stream are produced in the flow of the mixture of the gases G, G′, and by a combination of these streams, the Karman's vortex is generated downstream of the small column element 62 for agitating in the pipe 1. The mixture of the gases G, G′ is agitated sufficiently by the Karman's vortex and therefore the mixed gas flowing in the pipe 1 is able to be mixed sufficiently in the mixing region 38 of a short distance even though the flow of the exhaust gas G (the gas main stream) in the pipe 1 is a laminar flow or the turbulence of the flow of the gas main stream is small. In short, the mixture of gases flowing in the pipe 1 may be mixed uniformly at a short distance.

In the above-mentioned small column element 62 for agitating, the central section 62a of the small column element is positioned at the position of the axial center Z′ of the pipe 1, and each end of four arms 65 extending radially in the direction of a diameter of the pipe 1 is secured to the surrounding wall q of the pipe 1.

The configuration of the small column element for agitating is not limited to the configuration having four arms, and the configuration formed so as to be symmetric with respect to an axis as far as possible such as that consisting of six arms of which adjacent arms form an angle of 60° between them may be used.

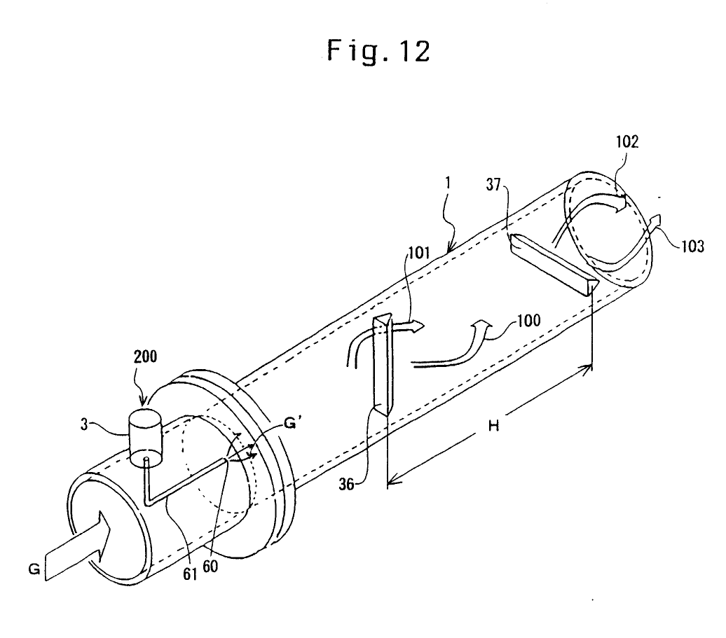

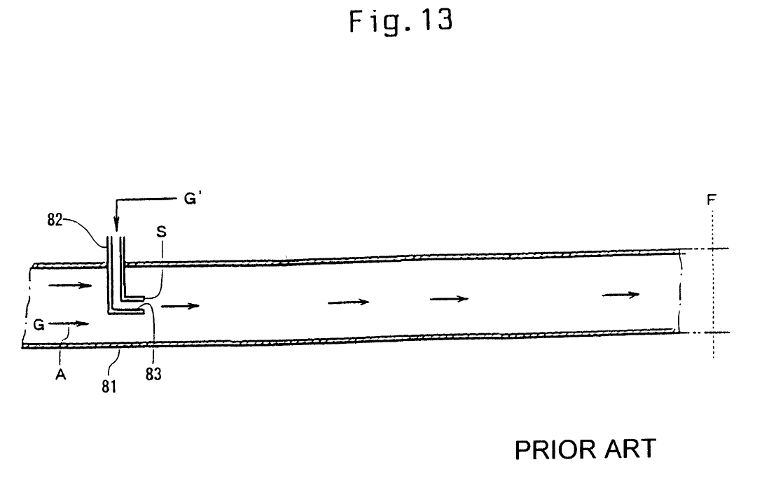

FIG. 12 shows the fifth embodiment of the present invention in which the L-shaped tube 61 bended in the form of a letter L in a state of directing the injection port 60 downstream is connected to the injection gas supplying port 3 and the small column elements 36, 37 for agitating having identical configurations are installed downstream of the above-mentioned injection section 200 allowing a space H between them. In FIG. 12, similar reference characters to that shown in FIGS. 1 to 11 designate similar or corresponding parts.

Also in this case, the straight flow of the mixture of the gases formed by mixing the injection gas G′ into the exhaust gas G to the above-mentioned direction of the gas main stream (direction shown by the arrow A) is obstructed by the above-mentioned small column element 36 and therefore the rightward-directing stream 100 and the leftward-directing stream 101 are produced in the flow of the mixture of the gases, and the straight flows of the above-mentioned rightward-directing stream 100 and the above-mentioned leftward-directing stream 101 of the mixture of the gases to the above-mentioned direction of the gas main stream (direction shown by the arrow A) are obstructed by the above-mentioned small column element 37 and the upward-directing stream 102 and the downward-directing stream 103 are produced in the flow of the mixture of the gases. By a combination of these rightward-directing stream 100 and leftward-directing stream 101, upward-directing stream 102 and downward-directing stream 103, the Karman's vortex is generated downstream of the above-mentioned small column element 37 in the pipe 1. Therefore, the mixture of the gases formed by mixing the injection gas G′ into the exhaust gas G may be agitated uniformly and sufficiently.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fluid mixing apparatus including a pipe in which fluid flows, an injection section for injecting an injection gas into the fluid and a supplying section for supplying the injection gas to the injection section, the apparatus further comprising:
at least one element downstream of the injection section, the at least one element extending inwardly from a surrounding wall of the pipe to agitate the injection gas and the fluid and to uniformly mix the injection gas in the fluid.

2. The apparatus of claim 1 wherein the at least one element comprises at least one column element having a top end and a bottom end with both the top end and the bottom end being secured to the surrounding wall of the pipe.

3. The apparatus of claim 2 wherein the at least one element further comprises a first column element downstream of the injection section and a second column element downstream of the first column element.

4. The apparatus of claim 1 wherein the at least one element comprises a plurality of branched tube sections extending radially from a central section in various directions.

5. The apparatus of claim 1 further comprising:
an injection tube in the injection section, the injection tube including a central section and at least one branched tube section, the at least one branched tube section extending outwardly from the central section and having a plurality of holes directed upstream for uniformly injecting the injection gas.

6. The apparatus of claim 5 wherein the injection tube comprises a plurality of branched tube sections branching radially from the central section in various directions wherein the plurality of holes are uniformly spaced about a cross-section of the pipe.

7. A fluid mixing apparatus including a pipe in which fluid flows, an injection section for injecting an injection gas into the fluid and a supplying section for supplying the injection gas to the injection section, the apparatus further comprising:
an injection tube in the injection section, the injection tube including a central section and at least one branched tube section, the at least one branched tube section extending outwardly from the central section and having a plurality of holes directed upstream for uniformly injecting the injection gas.

8. The apparatus of claim 7 wherein the injection tube comprises a plurality of branched tube sections branching radially from the central section in various directions wherein the plurality of holes are uniformly spaced about a cross-section of the pipe.
